(19) United States
(12) Patent Application Publication
(10) Pub. No.: US 2017/0115850 A1
(43) Pub. Date: Apr. 27, 2017

(54) DESKTOP DISPLAY CONTROL METHOD AND DEVICE

(71) Applicants: Le Holdings (Beijing) Co., Ltd., Beijing (CN); LE SHI ZHI XIN ELECTRONIC TECHNOLOGY (TIANJIN) LIMITED, Tianjin (CN)

(72) Inventor: Hui ZHAO, Tianjin (CN)

(21) Appl. No.: 15/247,878

(22) Filed: Aug. 25, 2016

Related U.S. Application Data
(63) Continuation of application No. PCT/CN2016/086981, filed on Jun. 24, 2016.

(30) Foreign Application Priority Data
Oct. 23, 2015 (CN) 2015106967554

(51) Int. Cl. G06F 3/0481; H04N 21/61; H04N 21/81; H04N 21/431

(52) U.S. Cl. CPC G06F 3/04817; H04N 21/4312; H04N 21/6125; H04N 21/8166

(57) ABSTRACT

Disclosed are a desktop display control method and device. The method includes: when receiving an enabled instruction for an icon on a desktop view, searching application information of an application corresponding to the icon; extracting invocation information of the application from the application information; and enabling the application according to the invocation information. According to the present invention, the desktop view is simpler and clearer. A user can enable various applications on the desktop view rapidly, and can watch a live video program or an on-demand program.

### CROSS-REFERENCE TO RELATED APPLICATIONS

This application is a continuation of International Application No. PCT/CN2016/086981, filed on 24 Jun. 2016, which is based upon and claims priority to Chinese Patent Application No. 201510696755.4, filed on 23 Oct. 2015, the entire contents of which are incorporated herein by reference.

### TECHNICAL FIELD

The present invention relates to the technical field of terminal display, and particularly relates to a desktop display control method and apparatus.

### BACKGROUND

Smart televisions and IPTV set top boxes entered thousands of families, and such product is equipped with a desktop provided by a manufacturer and provides functions of default programs, application arrangement, uninstallation and position change and other system functions. Currently, vast users of the smart televisions and IPTV set top boxes require a simpler and clearer interface which can replace an original desktop of a terminal. Moreover, users need to rapidly enable applications on the interface, and also need to implement television applications on the interface, i.e. users can view a great amount of live video programs or on-demand programs provided by professional video service providers. In addition, due to business cooperation and the requirement for providing guidance of downloading excellent applications to users, a space for recommended applications need to be spared on the desktop so as to facilitate downloading and usage for users.

### SUMMARY

Various embodiments of the present invention provide a desktop display control method and apparatus. The technical solution is as follows.

In the first aspect, the embodiments of the present disclosure provide a desktop display control method, which includes: receiving an enabled instruction for an icon on a desktop, and searching application information corresponding to the icon; extracting invocation information of the application from the application information; and launching the application according to the invocation information.

Another aspect of the present invention provides an electronic device, including a memory and at least one processor; where the memory is connected to the at least one processor, the memory is configured to store a computer instruction, and when the device runs, the at least one processor executes the computer instruction stored in the memory to enable the device to execute the following operations: receiving an enabled instruction for an icon on a desktop, and searching application information corresponding to the icon; extracting invocation information of the application from the application information; and launching the application according to the invocation information.

Another aspect of the present disclosure provides a non-volatile computer readable storage medium storing a computer instructions, and a computer executes the computer instruction to execute the following operations: receiving an enabled instruction for an icon on a desktop, and searching application information corresponding to the icon; extracting invocation information of the application from the application information; and launching the application according to the invocation information.

It should be understood that the general description above and the detailed description below are only exemplary and explanatory, but cannot limit the present invention.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a desktop display control method according to an embodiment of the present invention;

FIG. 2 is a flow chart of a desktop display control method according to another embodiment of the present invention;

FIG. 3 is a flow chart of a desktop display control method according to another embodiment of the present invention;

FIG. 4 is a flow chart of a desktop display control method according to another embodiment of the present invention;

FIG. 5 is a flow chart of a desktop display control method according to another embodiment of the present invention;

FIG. 6 is a block diagram of a desktop display control apparatus according to an embodiment of the present invention;

FIG. 7 is a block diagram of a desktop display control apparatus according to another embodiment of the present invention;

FIG. 8 is a block diagram of a desktop display control apparatus according to another embodiment of the present invention.

FIG. 9 is a block diagram of a network apparatus which can implement the desktop display control method according to the present invention.

### DETAILED DESCRIPTION

Exemplary embodiments will be illustrated in details herein, and examples of the embodiments are shown in the accompanying drawings. When the description below relates to the accompany drawings, unless otherwise stated, the same numbers in different accompany drawings represent the same or similar elements. Implementation modes described in the following exemplary embodiments do not represent all implementation modes consistent with the present invention. Conversely, the embodiments are only examples of apparatuses and methods which are consistent with the detailed description in the attached claims and in some aspects of the present invention

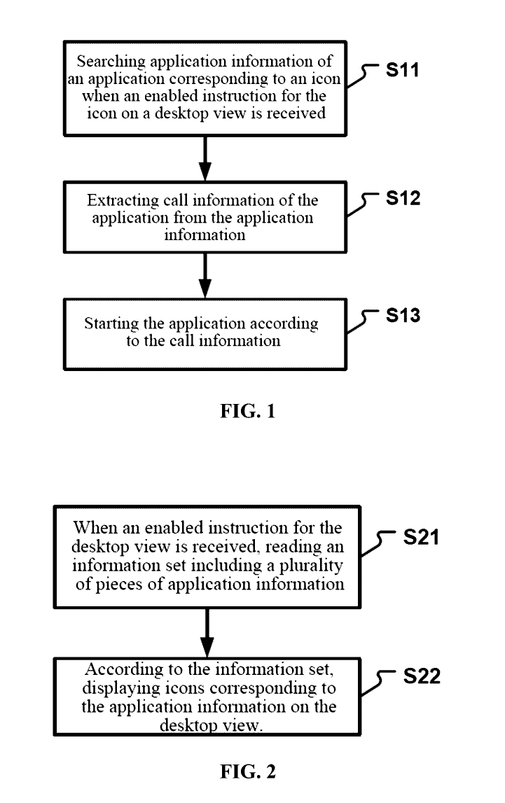

FIG. 1 is a flow chart of a desktop display control method of an embodiment of the present invention. As shown in FIG. 1, the desktop display control method is used in a smart television or an IPTV set top box, and includes the following steps.

S11, receiving an enabling instruction for an icon on a desktop view, and searching application information of an application corresponding to the icon.

The application information includes the icon, an application name, a package name, a class name, the invocation information, a position identifier, and a class identifier, that correspond to the application;

S12, extracting invocation information of the application from the application information; and

S13, enabling (launching) the application according to the invocation information.

In the present embodiment, in an operation system of the existing smart television or IPTV set top box, a new desktop is added to replace an original desktop, and the desktop is simpler and clearer, so that a user can rapidly enable various applications on the desktop, and can view live video programs or on-demand programs.

The desktop view (View) can include a plurality of sub-views (PagedViewIcons), i.e. each screen of desktop corresponds to one sub-view. 5*3 icons can be arranged on each screen of desktop. Each PagedViewIcon corresponds to a set of application information of 15 icons in the PagedViewIcon.

FIG. 2 is a flow chart of a desktop display control method of another embodiment of the present invention. As shown in FIG. 2, in another embodiment, the method further includes: S21, receiving an enabled instruction for the desktop view, reading an information set including pieces of application information; and S22, according to the information set, displaying, on the desktop, icons that correspond to the application information.

In the present embodiment, when the desktop is enabled, firstly, the set of pieces of application information can be read from a database, and the icons of the applications are displayed on the desktop.

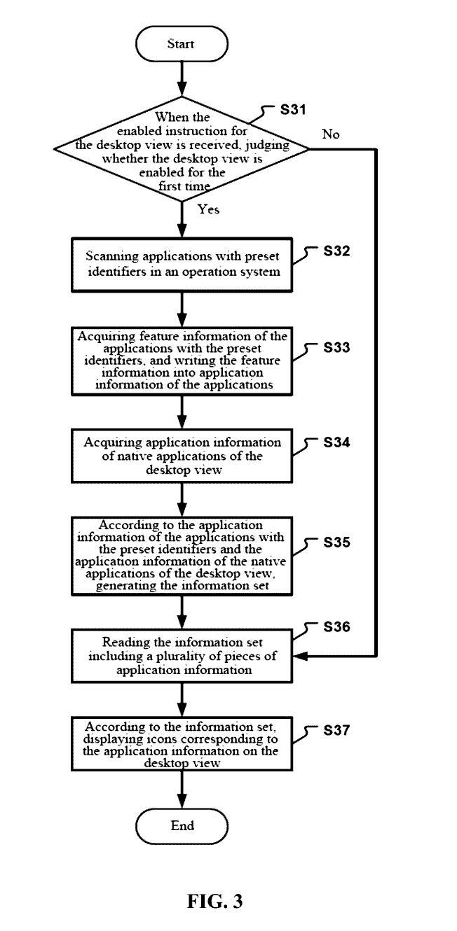

FIG. 3 is a flow chart of a desktop display control method of another embodiment of the present invention. As shown in FIG. 3, in another embodiment, the method further includes:

S31, upon receiving the enabled instruction for the desktop view, judging whether the desktop view is enabled for the first time, executing the step S32 when the desktop view is enabled for the first time, and when the desktop view is not enabled for the first time, executing the step S36;

S32, scanning in an operation system applications that are equipped with preset identifiers;

S33, acquiring feature information of the applications with the preset identifiers, and writing the feature information into application information of the applications;

S34, acquiring application information of native applications of the desktop view;

S35, according to the application information of the applications with the preset identifiers and the application information of the native applications of the desktop view, generating the information set;

S36, reading the information set including pieces of application information; and

S37, according to the information set, displaying icons that correspond to the application information on the desktop view.

In the present embodiment, the desktop view is further judged whether to be enabled for the first time, and if the desktop view is enabled for the first time, the applications loaded with the preset identifiers in the system, such as applications installed by a user, will be scanned firstly. The feature information of the applications are written into the application information, plus the application information of the native application of the system, and the information set is generated. Therefore, when the desktop view is opened, the icons of the applications can be displayed.

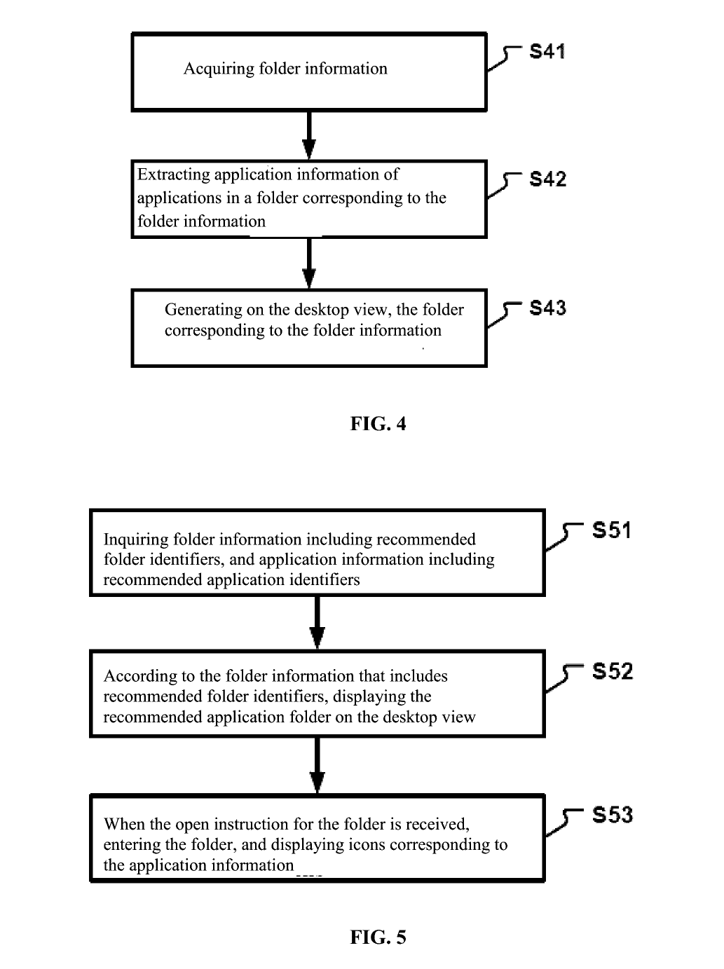

FIG. 4 is a flow chart of a desktop display control method of another embodiment of the present invention. As shown in FIG. 4, in another embodiment, the step S21 includes: S41: acquiring folder information; and S42: according to the folder information, extracting application information of applications in a folder corresponding to the folder information.

The step S22 includes: S43, generating the folder corresponding to the folder information on the desktop view.

In the present embodiment, if folders exist on the desktop view, each folder corresponds to one piece of folder information (FolderPagedViewIcon) for displaying the folder, and each folder is suitable for movement and sorting of a plurality of icons. The application information of the applications in the folders includes identifiers of the folders, which facilitates search of the applications in the folders later.

In another embodiment, the method further includes: when receiving an open instruction for one folder, entering the folder, and displaying icons in the folder on the desktop view.

FIG. 5 is a flow chart of a desktop display control method of another embodiment of the present invention. As shown in FIG. 5, in another embodiment, a recommended application folder exists on the desktop view, and the step S21 includes: S51, inquiring folder information including recommended folder identifiers and application information including recommended application identifiers.

The step S22 further includes: S52, according to the folder information including the recommended folder identifiers, displaying the recommended application folder on the desktop view; and S53, upon receiving the open instruction for the folder, entering the folder, and displaying icons corresponding to the application information including the recommended application identifiers on the desktop view.

In the present embodiment, recommended applications are placed in the recommended folder, so that the desktop view is much simpler. The recommended applications thus cannot interfere with the user, and a desktop space is convenient to be utilized. Moreover, an application recommendation is able to add icons similar to applications on a desktop to the tiled desktop, a secondary application interface can appear when the icons are clicked on, and the secondary interface is similar to a primary interface in style.

Due to addition of the recommended folder, in program codes of the desktop view, the following contents needs to be added:

A class AppsRecommend is added and is used for recommended applications configured according to different channels. Each application provides a name, an icon, a downloadURL and a package name. The said class is a singleton class, and an acquisition method is provided.

One class of applications and folders with recommendation identifiers is added to a View class of PagedViewIcon of applications and a View class of folder information of folders.

Processing is added to a MoveController class for controlling position movement of the icons so as to forbid movement of the recommended application folder.

An application downloading function and an installation prompting function are added to a DownloadService class for controlling downloading.

Identifiers are added into a database class T2LauncherDao of a storage AppInfo class to determine whether the applications and the folders are recommended so as to facilitate storage.

A folder example is added into an AppsCustomizePagedView which takes charge of loading of all Views, and related recommended applications are added.

The recommended application folder is also an AppInfo, and thus, the recommended application folder is specially marked in the storage process.

Embodiments of an apparatus of the present invention are as follows, and can be used for executing the embodiments of the method of the present invention.

FIG. 6 is a block diagram of a desktop display control apparatus of an embodiment of the present invention. The apparatus can be implemented by software, hardware or combination of the software and the hardware to become a part or all of electronic equipment. As shown in FIG. 6, the desktop display control apparatus includes: a searching module 601, which is used for searching application information of an application corresponding to an icon when an enabled instruction for the icon on a desktop view is received; an extraction module 602, which is used for extracting invocation information of the application from the application information; and an enabling module 603, which is used for enabling the application according to the invocation information.

Preferably, the application information includes the icon, an application name, a package name, a class name, the invocation information, a position identifier, and a class identifier, all of which correspond to the application.

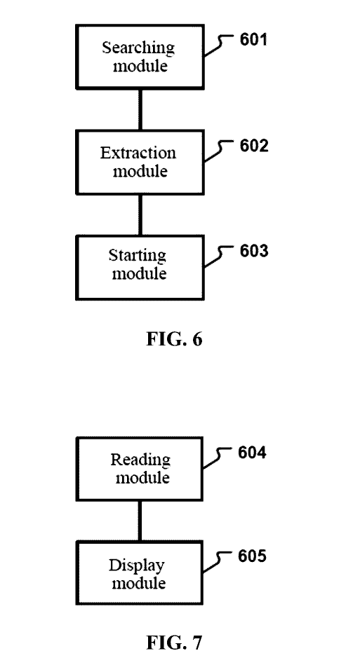

FIG. 7 is a block diagram of a desktop display control apparatus of another embodiment of the present invention. As shown in FIG. 7, preferably, the apparatus further includes: a reading module 604, which is used for reading an information set including a plurality of pieces of application information when an enable instruction for the desktop view is received; and a display module 605, which is used for displaying icons corresponding to the application information on the desktop view according to the information set.

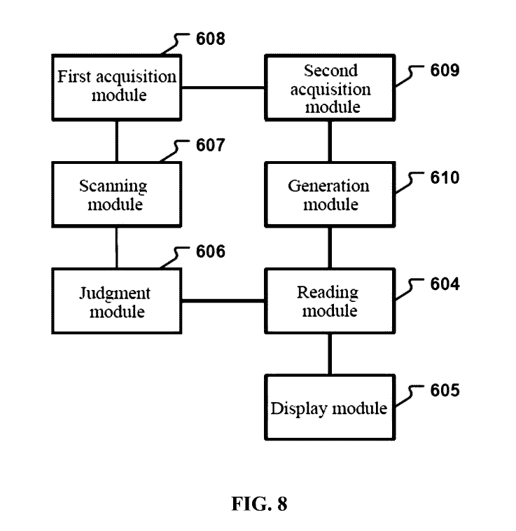

FIG. 8 is a block diagram of a desktop display control apparatus of another embodiment of the present invention. As shown in FIG. 8, preferably, the apparatus further includes: a judgment module 606, which is used for judging whether the desktop view is enabled for the first time when the enabled instruction for the desktop view is received; a scanning module 607, which is used for scanning applications with preset identifiers in an operation system when the desktop view is enabled for the first time; a first acquisition module 608, which is used for acquiring feature information of the applications with the preset identifiers and writing the feature information into application information of the applications; a second acquisition module 609, which is used for acquiring application information of native applications of the desktop view; and a generation module 610, which is used for generating the information set according to the application information of the applications with the preset identifiers and the application information of the native applications of the desktop view.

Preferably, the reading module 604 is used for acquiring Folder information, and extracting application information of applications in a folder corresponding to the Folder information according to the Folder information; and the display module 605 is used for generating the folder corresponding to the Folder information on the desktop view.

Preferably, the display module 605 is also used for entering the folder and displaying icons in the folder on the desktop view when an open instruction for the folder is received.

Preferably, the reading module 604 is used for inquiring folder information including recommended file identifiers and application information including recommended application identifiers when a recommended application folder exists on the desktop view; and the display module 605 is used for displaying the recommended application folder on the desktop view according to the folder information including the recommended folder identifiers and when the open instruction for the folder is received, entering the folder and displaying icons corresponding to the application information including the recommended application identifiers on the desktop view.

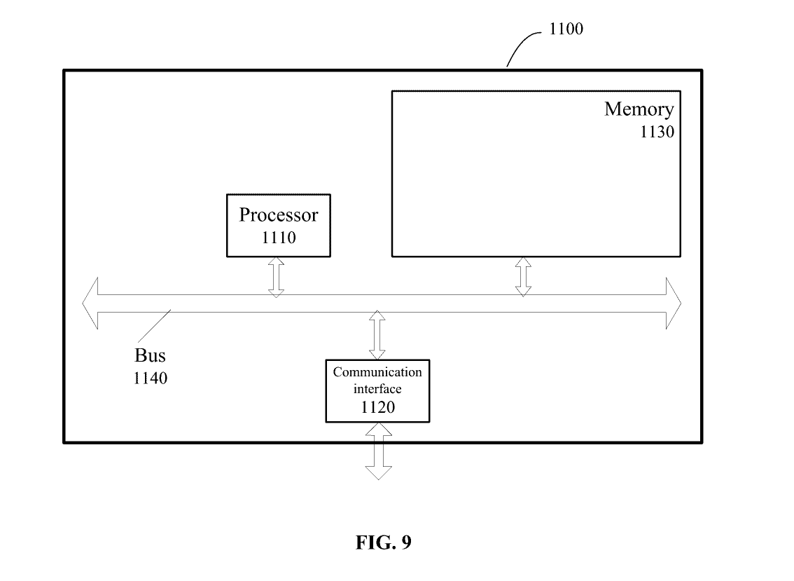

FIG. 9 is a block diagram of a network apparatus which can implement the desktop display control method according to the present invention. The network device 1100 may be a host server, a personal computer (PC), or a portable computer or terminal and the like with computing power. The specific embodiments of the present invention do not limit concrete implementation of computing nodes.

The network device 1100 includes a processor 1110, a communications interface 1120, a memory (memory array) 1130 and a bus 1140, wherein the processor 1110, the communications interface 1120 and the memory 1130 communicate with one another through the bus 1140.

The communications interface 1120 is used for communicating with a network element, wherein the network element includes, for example, a virtual machine management center, shared storage and the like.

The processor 1110 is used for executing programs. The processor 1110 may be a central processing unit (CPU), or an ASIC (Application Specific Integrated Circuit), or one or more integrated circuits configured to implement the embodiments of the present invention.

The memory 1130 is used for storing files. The memory 1130 may include a high-speed RAM memory, and may also include a non-volatile memory, for example, at least one disk memory. The memory 1130 also can be a memory array. The memory 1130 may also be partitioned into blocks, and the blocks can be combined into a virtual volume according to a certain rule.

In a possible embodiment, the above-mentioned programs may be program codes including computer operating instructions. Execution of the instructions by the processor causes the processor to: receive an enabled instruction for an icon on a desktop, and search application information corresponding to the icon; extract invocation information of the application from the application information; and launch the application according to the invocation information.

In a preferred embodiment, the application information comprises the icon, an application name, a package name, a class name, the invocation information, a position identifier, and a class identifier which correspond to the application.

In a preferred embodiment, execution of the instructions by the processor further causes the at least one processor to: receive an enabled instruction for the desktop view, and read an information set including pieces of application information; and display icons corresponding to the pieces of application information onto the desktop view, according to the information set.

In a preferred embodiment, when the enabled instruction for the desktop view is received, execution of the instructions by the at least one processor further causes the at least one processor to: judge whether the desktop view is enabled for the first time; when the desktop view is enabled for the first time, scan, in an operation system, applications with preset identifiers; acquire feature information of the applications with the preset identifiers, and write the feature information into application information of the applications; acquire application information of native applications of the desktop view; and according to the application information of the applications with the preset identifiers as well as the application information of the applications of the native desktop view, generate the information set.

It will be appreciated by those skilled in the art that the embodiments of the present invention can provide a method, a system, or a computer program product. Therefore, the present invention can adopt a form of full-hardware embodiments, full-software embodiments, or embodiments with combination of hardware and software. Moreover, the present invention can adopt a form of the computer program product implemented on one or more computer-available storage media (including but not limited to a disk memory and an optical memory, etc.) containing computer-available program codes.

The present invention is described with reference to the flow diagram and/or block diagram of the method, the device (system), and the computer program product according to embodiments of the present invention. It should be appreciated that every flow and/or block in the flow diagram and/or block diagram, and the combination of the flows and/or blocks in the flow diagram and/or block diagram can be implemented by computer program instructions. These computer program instructions can be provided to a processor of a general-purpose computer, a special-purpose computer, an embedded type processor or other programmable data processing equipment to create a machine so as to ensure that the instructions executed by the processor of a computer or other programmable data processing equipment create a device for realizing a specified function in one or more flows of the flow diagram and/or one or more blocks of the block diagram.

These computer program instructions also can be stored in a computer-readable memory which can guide the computer or other programmable data processing equipment to work in a specific mode, so that the instructions stored in the computer-readable memory generate a manufactured product comprising an instruction device which realizes the specific function in one or more flows of the flow diagram and/or one or more blocks of the block diagram.

These computer program instructions also can be loaded to the computer or other programmable data processing equipment to ensure that a series of operation steps are executed on the computer or other programmable data processing equipment so as to generate computer-implementing processing, so that the instructions executed on the computer or other programmable data processing equipment provide steps for realizing the specific function in one or more flows of the flow diagram and/or one or more blocks of the block diagram.

In regard to the apparatus in the embodiments, specific modes of executing operations of each module have been described in details in the embodiments related to the method, and will not be illustrated in details herein.

Those skilled in the art will easily think of other implementation solutions of the present invention after considering the specification and practicing the disclosure disclosed herein. The application is intended to cover any modifications, applications or adaptive variations of the present invention, and the modifications, applications or adaptive variations follow the general principle of the present invention and include common general knowledge or conventional technological means in the technical art, which are not disclosed by the present invention. The specification and the embodiments are only regarded as examples, and the true scope and spirit of the present invention are indicated by the claims below.

It should be understood that the present invention is not limited to accurate structures which have been described and shown in the accompanying drawings, and various modifications or changes can be made without departing from the scope of the present invention. The scope of the present invention is only limited by the attached claims.

What is claimed is:

1. A desktop display control method implemented by a terminal, comprising:
receiving an enabled instruction for an icon on a desktop, and searching application information corresponding to the icon;
extracting invocation information of the application from the application information; and
launching the application according to the invocation information.

2. The method according to claim 1, wherein the application information comprises the icon, an application name, a package name, a class name, the invocation information, a position identifier, and a class identifier which correspond to the application.

3. The method according to claim 2, further comprising:
receiving an enabled instruction for the desktop, and reading an information set including pieces of application information; and
displaying icons corresponding to the pieces of application information onto the desktop, according to the information set.

4. The method according to claim 3, wherein when the enabled instruction for the desktop is received, the method further comprises:
judging whether the desktop is enabled for the first time;
when the desktop is enabled for the first time, scanning, in an operation system, applications with preset identifiers;
acquiring feature information of the applications with the preset identifiers, and writing the feature information into application information of the applications;
acquiring application information of native applications of the desktop; and
according to the application information of the applications with the preset identifiers as well as the application information of the applications of the native desktop, generating the information set.

5. The method according to claim 3, wherein the step of reading the information set comprises:
acquiring folder information; and
according to the folder information, extracting application information in a folder corresponding to the folder information,
wherein the step of displaying icons corresponding to the pieces of application information on the desktop according to the information set, comprises: generating the folder corresponding to the folder information on the desktop.

6. The method according to claim 5, further comprising:
receiving an open instruction for one folder, entering the folder, and displaying the icons located in the folder on the desktop.

7. The method according to claim 6, wherein a recommended application folder exists on the desktop view, and
the step of reading the information set comprises: inquiring folder information including recommended folder identifiers and application information including recommended application identifiers; and
the step of displaying the icons corresponding to the application information on the desktop view according to the information set, comprises: according to the folder information including the recommended folder identifiers, displaying the recommended application folder on the desktop view; and upon receiving the open instruction for the folder, entering the folder, and displaying icons corresponding to the application information including the recommended application identifiers on the desktop view.

8. An electronic device, comprising:
at least one processor; and
a memory communicably connected with the at least one processor for storing instructions executable by the at least one processor, wherein execution of the instructions by the at least one processor causes the at least one processor to:
receive an enabled instruction for an icon on a desktop, and search application information corresponding to the icon;
extract invocation information of the application from the application information; and
launch the application according to the invocation information.

9. The electronic device according to claim 8, wherein the application information comprises the icon, an application name, a package name, a class name, the invocation information, a position identifier, and a class identifier which correspond to the application.

10. The electronic device according to claim 8, wherein execution of the instructions by the at least one processor further causes the at least one processor to:
receive an enabled instruction for the desktop view, and read an information set including pieces of application information; and
display icons corresponding to the pieces of application information onto the desktop view, according to the information set.

11. The electronic device according to claim 8, wherein when the enabled instruction for the desktop view is received, execution of the instructions by the at least one processor further causes the at least one processor to:
judge whether the desktop view is enabled for the first time;
when the desktop view is enabled for the first time, scan, in an operation system, applications with preset identifiers;
acquire feature information of the applications with the preset identifiers, and write the feature information into application information of the applications;
acquire application information of native applications of the desktop view; and
according to the application information of the applications with the preset identifiers as well as the application information of the applications of the native desktop view, generate the information set.

12. The electronic device according to claim 10, wherein the execution of the instructions causes the at least one processor to read an information set comprises:
acquiring folder information; and
according to the folder information, extracting application information in a folder corresponding to the folder information,
wherein execution of the instructions causes the at least one processor to display icons corresponding to the pieces of application information on the desktop according to the information set, comprises: generating the folder corresponding to the folder information on the desktop.

13. The electronic device according to claim 12, wherein the execution of the instructions further causes the at least one processor to:
receive an open instruction for one folder, entering the folder, and display the icons located in the folder on the desktop.

14. The electronic device according to claim 13, wherein a recommended application folder exists on the desktop view, and
the execution of the instructions causes the at least one processor to read an information set comprises: inquiring folder information including recommended folder identifiers, and application information including recommended application identifiers; and
the execution of the instructions causes the at least one processor to display the icons corresponding to the application information on the desktop view according to the information set, comprises: according to the folder information including the recommended folder identifiers, displaying the recommended application folder on the desktop view; and upon receiving the open instruction for the folder, entering the folder, and displaying icons corresponding to the application information including the recommended application identifiers on the desktop view.

15. A non-transitory computer-readable storage medium storing executable instructions that, when executed by an electronic device with a touch-sensitive display, cause the electronic device to:
receive an enabled instruction for an icon on a desktop, and search application information corresponding to the icon;
extract invocation information of the application from the application information; and
launch the application according to the invocation information.

16. The non-transitory computer-readable storage medium according to claim 15, wherein the application information comprises the icon, an application name, a package name, a class name, the invocation information, a position identifier, and a class identifier which correspond to the application.

17. The non-transitory computer-readable storage medium according to claim 15, wherein execution of the instructions by the electronic device further causes the electronic device to:
receive an enabled instruction for the desktop view, and read an information set including pieces of application information; and
display icons corresponding to the pieces of application information onto the desktop view, according to the information set.

18. The non-transitory computer-readable storage medium according to claim 17, wherein when the enabled instruction for the desktop view is received, execution of the instructions further causes the electronic device to:
judge whether the desktop view is enabled for the first time;
when the desktop view is enabled for the first time, scan, in an operation system, applications with preset identifiers;
acquire feature information of the applications with the preset identifiers, and write the feature information into application information of the applications;
acquire application information of native applications of the desktop view; and
according to the application information of the applications with the preset identifiers as well as the application information of the applications of the native desktop view, generate the information set.

19. The non-transitory computer-readable storage medium according to claim 17, wherein the execution of the instructions causes the electronic device to read an information set comprises:
acquiring folder information; and
according to the folder information, extracting application information in a folder corresponding to the folder information,
wherein execution of the instructions causes the electronic device to display icons corresponding to the pieces of application information on the desktop according to the information set, comprises: generating the folder corresponding to the folder information on the desktop.

20. The non-transitory computer-readable storage medium according to claim 19, wherein the execution of the instructions further causes the electronic device to:
receive an open instruction for one folder, entering the folder, and display the icons located in the folder on the desktop.
